(19) United States
(12) Patent Application Publication
(10) Pub. No.: US 2026/0158664 A1
(43) Pub. Date: Jun. 11, 2026

(54) INSTRUCTION DEVICE, ROBOT SYSTEM, AND ROBOT

(71) Applicant: Panasonic Intellectual Property Management Co., Ltd., Osaka (JP)

(72) Inventor: SATORU SUZUKI, Osaka (JP)

(21) Appl. No.: 19/537,611

(22) Filed: Feb. 12, 2026

Related U.S. Application Data
(63) Continuation of application No. PCT/JP2024/037325, filed on Oct. 21, 2024.

(30) Foreign Application Priority Data
Nov. 22, 2023 (JP) 2023-198182

(51) Int. Cl. B25J 9/16

(52) U.S. Cl. CPC B25J 9/1697

(57) ABSTRACT

An instruction device includes a feature amount integrator that generates a third feature amount on the basis of a first feature amount of image data held by a first user and a second feature amount of image data held by a second user, the third feature amount being obtained by integrating the first feature amount and the second feature amount, a determiner that determines whether to execute an output to the second user on the basis of similarity between the third feature amount and a fourth feature amount extracted from image data of an external environment, and an instructor that performs an instruction of the output in a case where it is determined to execute the output to the second user.

### DESCRIPTION

### TECHNICAL FIELD

The present disclosure relates to an instruction device, a robot system, and a robot.

### BACKGROUND ART

In recent years, a technique of an imaging device capable of acquiring a video image preferred by a user without requiring a special operation by the user has been proposed. PTL 1 proposes an imaging device in which weighting of data related to a captured image instructed by a user is made larger than weighting of data related to a captured image automatically processed on the basis of data related to the captured image.

### Citation List

### Patent Literature

PTL 1: Unexamined Japanese Patent Publication No. 2019-106694

### SUMMARY OF THE INVENTION

The technique described in PTL 1 only acquires a photograph according to the preference of a single user, and cannot acquire a photograph according to the preferences of two or more users in a case where there are two or more users.

An object of the present disclosure is to provide an instruction device, a robot system, and a robot capable of making a photographing proposal according to preferences of two or more users.

One aspect of an instruction device according to the present disclosure includes a feature amount integrator that generates a third feature amount on the basis of a first feature amount of image data held by a first user and a second feature amount of image data held by a second user, the third feature amount being obtained by integrating the first feature amount and the second feature amount, a determiner that determines whether to execute an output to the second user on the basis of similarity between the third feature amount and a fourth feature amount extracted from image data of an external environment, and an instructor that performs an instruction of the output in a case where it is determined to execute the output to the second user.

One aspect of a robot system of the present disclosure includes the instruction device described above and a robot that acts in response to an instruction from the instruction device.

One aspect of the robot of the present disclosure includes the instruction device described above.

### Advantageous effect of invention

The present disclosure can make a photographing proposal according to preferences of two or more users.

### BRIEF DESCRIPTION OF THE DRAWINGS

FIG. 1 is a diagram illustrating an outline of a robot system according to the present exemplary embodiment.

FIG. 2 is a block diagram illustrating a functional configuration of the robot system according to the present exemplary embodiment.

FIG. 3 is a flowchart illustrating an action of the robot system.

FIG. 4 is a diagram illustrating an example of a case of creating a color histogram.

FIG. 5 is a diagram illustrating an example of a case of integrating feature amounts.

FIG. 6 is a diagram illustrating calculation of similarity of feature amounts.

FIG. 7 is a diagram illustrating an example of an action according to a magnitude of similarity.

### DESCRIPTION OF EMBODIMENT

Hereinafter, exemplary embodiments of the present disclosure will be described with reference to the drawings. Note that, the exemplary embodiments to be described below each illustrate one specific example of the present disclosure. Therefore, numerical values, shapes, materials, constituent elements, arrangement positions and connection forms of the constituent elements, steps and order of steps, and the like to be indicated in the following exemplary embodiment are examples, and they are not intended to limit the present disclosure. Among the constituent elements in the following exemplary embodiment, constituent elements not recited in the independent claims are described as optional constituent elements.

Each drawing is schematically illustrated and thus is not strictly accurate. Note that, in each drawing, substantially the same configurations are denoted by the same reference marks to eliminate or simplify duplicated description.

### Outline of robot

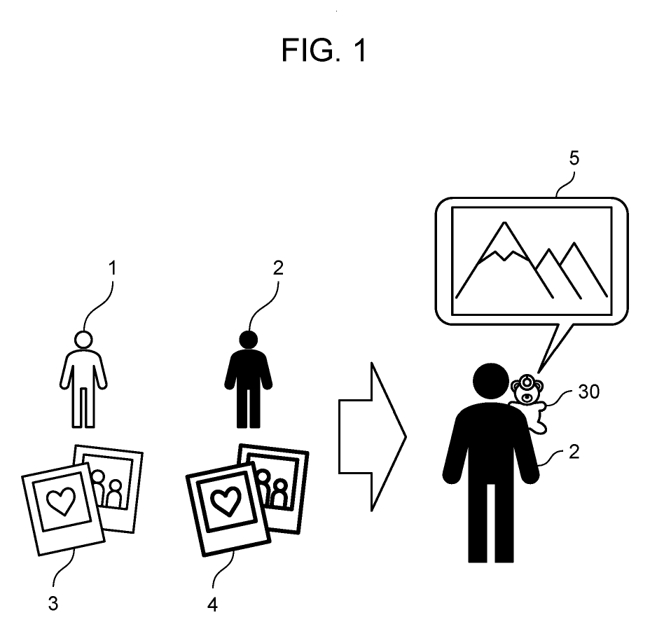

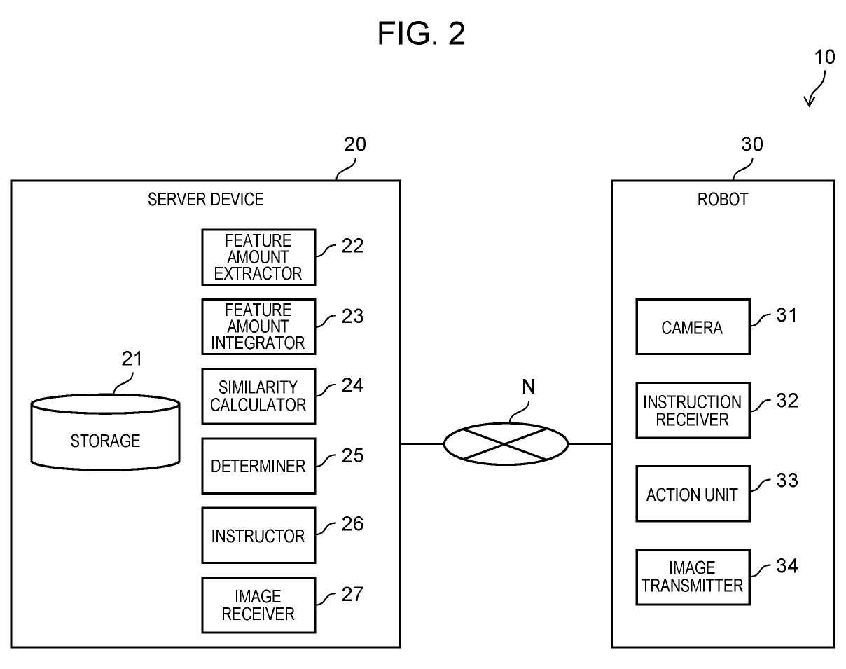

Hereinafter, a configuration of a robot system according to the present exemplary embodiment will be described. FIG. 1 is a diagram illustrating an outline of the robot system according to the present exemplary embodiment. FIG. 2 is a block diagram illustrating a functional configuration of robot system 10 according to the present exemplary embodiment.

Robot system 10 has a configuration in which server device 20 and robot 30 are connected via network N. Note that the configuration of robot system 10 is not required to be robot 30, and may be a terminal or the like. The terminal or the like only needs to include an imaging unit and an output device, and may be, for example, a smartphone or a tablet.

As illustrated in FIG. 1, server device 20 extracts preferences of users from photo data 3 and 4 owned by two or more users 1 and 2, and determines whether photo data 5 acquired from robot 30 matches the preferences of the users.

Note that photo data 3 and 4 owned by users 1 and 2 and photo data 5 acquired from robot 30 may be image (video) data, and are not limited to still image data, and may be moving image data obtained by capturing a moving image.

In a case where photo data 5 acquired from robot 30 matches the preferences of the users, robot 30 works on user 2 who owns robot 30 to capture a corresponding photograph. By using robot system 10 according to the present exemplary embodiment, it is possible to make a photographing proposal according to the preferences of two or more users.

### Configuration of robot system

Hereinafter, constituent elements included in robot system 10 described above will be described. Server device 20 is an instruction device that instructs robot 30 to execute an action of prompting photographing of an external environment. Server device 20 includes storage 21, feature amount extractor 22, feature amount integrator 23, a similarity calculator 24, determiner 25, instructor 26, and image receiver 27.

Storage 21 holds photo data 3 and 4 of two or more users 1 and 2. Photo data 3 and 4 are managed in association with an user ID so that the owner can be known. Storage 21 is implemented by, for example, a semiconductor memory or the like.

Feature amount extractor 22 extracts a first feature amount from photo data 3 and extracts a second feature amount from photo data 4. The feature amount to be extracted is, for example, an appearance frequency, color, texture, shape, and composition of a subject. The extracted feature amount is managed in association with the user ID. The extracted feature amount may be held in storage 21.

Feature amount integrator 23 weights and integrates the first feature amount and the second feature amount extracted from photo data 3 and 4 of two or more users 1 and 2 extracted by feature amount extractor 22, and generates a third feature amount. Then, feature amount integrator 23 causes storage 21 to hold the third feature amount.

Note that, in a case where the feature amounts extracted from photo data 3 and 4 of two or more users 1 and 2 are held in storage 21, feature amount integrator 23 may read and integrate the feature amounts extracted from the photo data of the two or more users from storage 21.

Similarity calculator 24 calculates a similarity between the third feature amount and a feature amount of a photograph acquired by robot 30. The photograph taken by robot 30 is sent from robot 30 to server 20 via network N.

Determiner 25 determines whether to execute an action of prompting photographing of the external environment of robot 30 on the basis of the similarity calculated by similarity calculator 24. Specifically, determiner 25 determines whether the similarity calculated by similarity calculator 24 satisfies a condition for executing the action of robot 30.

Instructor 26 instructs robot 30 via network N to execute the action of prompting photographing of the external environment when determiner 25 determines to execute the action of prompting photographing of the external environment.

Image receiver 27 receives photo data 5 acquired by camera 31 of robot 30 from image transmitter 34 of robot 30 via network N.

On the other hand, robot 30 includes camera 31, instruction receiver 32, action unit 33, and image transmitter 34. Camera 31 is an imaging device that captures a photograph of the external environment of robot 30. Note that camera 31 captures not only a photograph which is a still image, but may capture a moving image.

Instruction receiver 32 accepts an action instruction of robot 30 from instructor 26 of server device 20 via network N. The action instruction is, for example, information for instructing an action such as changing the color of the eyes of robot 30, changing the expression, moving the body, emitting a voice, or sending a notification to a mobile terminal possessed by user 2.

In a case where instruction receiver 32 accepts an instruction to operate robot 30 from server device 20, action unit 33 executes an action of prompting user 2 to photograph the external environment of robot 30.

Image transmitter 34 transmits photo data 5 acquired by camera 31 of robot 30 to instruction image receiver 27 of server device 20 via network N.

### Action of robot system

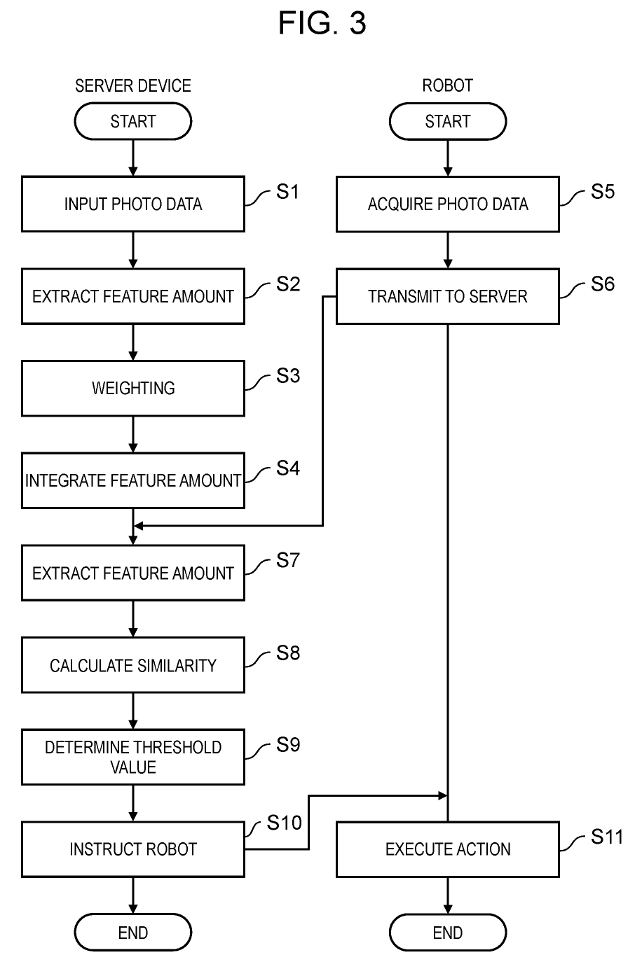

Next, the action of robot system 10 will be described. FIG. 3 is a flowchart illustrating the action of robot system 10. Note that the order of the pieces of processing indicated in the flowchart of FIG. 3 is an example. The order of the pieces of processing may be changed, or a plurality of pieces of processing may be executed in parallel.

First, storage 21 of server device 20 receives inputs of photo data 3 and 4 uploaded by users 1 and 2 to server device 20, and holds photo data 3 and 4 (step S1).

Photo data 3 and 4 may be, for example, photo data photographed by the user himself/herself with a smartphone camera or a digital camera, or photo data obtained by capturing a screen of a PC, a smartphone, or a tablet. Photo data 3 and 4 may be photo data downloaded from a social network or a website, or may be photo data received from another person.

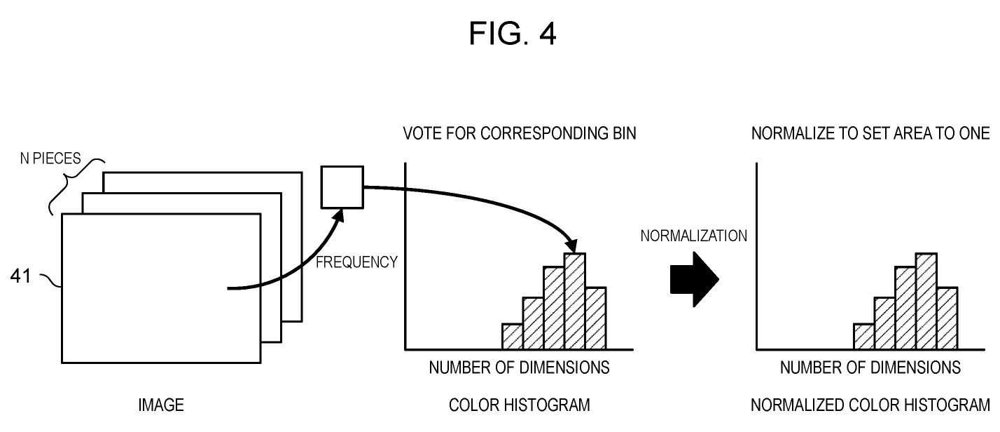

Next, feature amount extractor 22 acquires photo data 3 and 4 held in storage 21, extracts the first feature amount from photo data 3, and extracts the second feature amount from photo data 4 (step S2). Here, regarding the extraction of the feature amount, a case where feature amount extractor 22 extracts color information from the photo data of one user and creates a color histogram will be described. FIG. 4 is a diagram illustrating an example of a case of creating a color histogram.

The color histogram is obtained by examining color information of each pixel, counting the number of the colors, and expressing the counted number by a histogram. In a case where a color histogram is created by using a plurality of (N) images 41, feature amount extractor 22 adds the color histograms created from images 41 to create one color histogram.

In order to remove an influence of an image size and the number of images 41 from the created color histogram, feature amount extractor 22 normalizes the color histogram to set the area to one. In a case where an appearance frequency, texture, shape, and composition of the subject are extracted from photo data 3 and 4, feature amount extractor 22 creates a histogram by a method similar to the method in a case where a color histogram is created.

Next, feature amount integrator 23 weights the feature amount extracted in step S2 for each user (step S3). Then, feature amount integrator 23 integrates the first feature amount and the second feature amount extracted from photo data 3 and 4 of the two users, that is, user 1 and the user 2, on the basis of the weight set for the feature amount of each user (step S4).

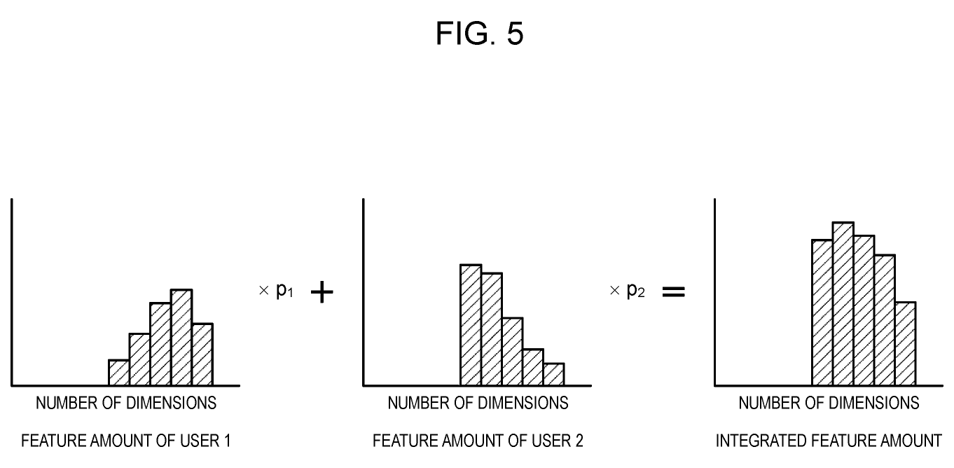

FIG. 5 is a diagram illustrating an example of a case of integrating feature amounts. In a case where the weight for the feature amount of user 1 is p₁, feature amount integrator 23 sets the weight for the feature amount of user 2 to p₂=1-p₁. That is, the sum of the weights is p₁+p₂=1. The value of the weight can be arbitrarily set by the user in a range of 0.0 ≤ p₁ ≤ 1.0, and when the weight of one user is set, the weight of the other user is automatically determined.

For example, in a case where p₁=0.5, p₂=0.5. This corresponds to a feature amount obtained by adding and averaging the feature amounts of user 1 and user 2. For example, in a case where the owner of robot 30 is user 2 and the preferences of user 1 and user 2 are different, feature amount integrator 23 preferably sets p₁=0.8 and p₂=0.2 to increase the specific gravity of the feature amount of user 1.

This is because user 2 can capture a photograph at his/her discretion, but a photograph preferred by user 1 has to rely on a photographing proposal by robot 30.

In a case of weighting the feature amounts of three users from user 1 to user 3, feature amount integrator 23 sets the weights for the feature amounts of user 1 and user 2 to p₁ and p₂, respectively, and sets weight p₃ for the feature amount of user 3 to p₃=1-(p₁+p₂). That is, the sum of the weights is p₁+p₂+p₃=1.

The value of the weight can be arbitrarily set by the user in a range of 0.0 ≤ p₁ ≤ 1.0 and 0.0 ≤ p₁+p₂ ≤ 1.0, and when the weights of two users of the three users are set, the weight of the other user is automatically determined.

On the other hand, camera 31 mounted on robot 30 performs photographing to acquire photo data 5 of the external environment (step S5). For example, camera 31 may acquire photo data 5 at any timing such as acquiring one piece per minute or one piece per five minutes.

Next, image transmitter 34 transmits photo data 5 acquired by camera 31 to image receiver 27 of server device 20 via network N (step S6).

Then, feature amount extractor 22 of server device 20 extracts a fourth feature amount from photo data 5 received from image transmitter 34 of robot 30 (step S7). The feature amount extraction method is similar to the extraction method in step S2. In a case where image transmitter 34 transmits an image to server 20, the image transmitter may compress and transmit the image in consideration of the load of network N.

Thereafter, similarity calculator 24 calculates the similarity between the third feature amount generated from photo data 3 and 4 of users 1 and 2 and the fourth feature amount extracted from photo data 5 acquired by robot 30 (step S8).

Similarity calculator 24 uses, for example, cosine similarity to calculate similarity. That is, similarity calculator 24 calculates the similarity by calculating cosine similarity between a feature vector including the third feature amount and a feature vector including the fourth feature amount.

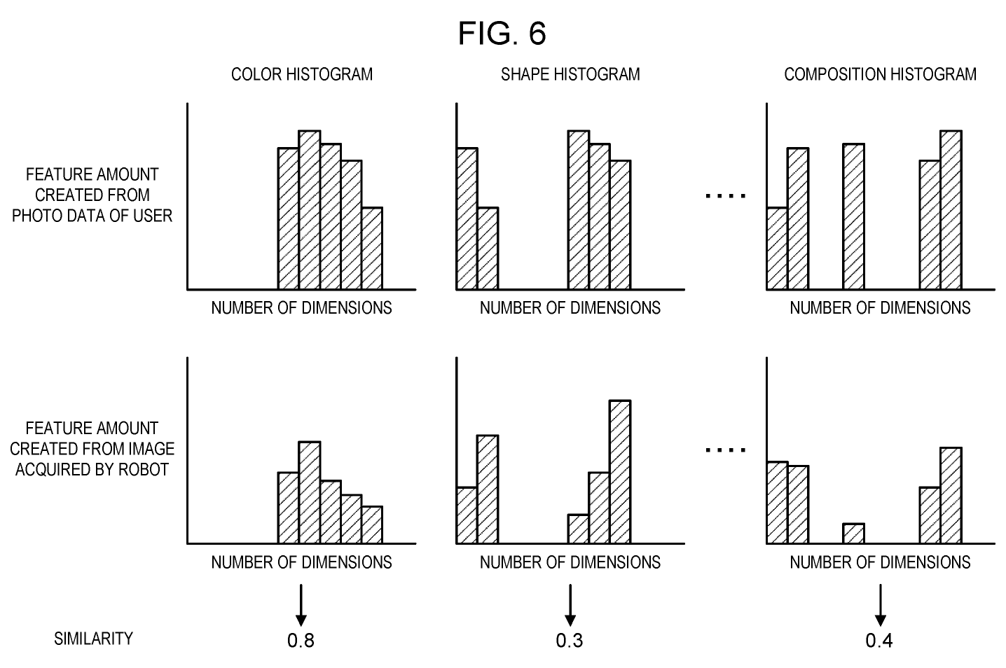

FIG. 6 is a diagram illustrating calculation of similarity of feature amounts. Here, in step S2 described above, similarity calculator 24 vectorizes each of a plurality of histograms such as a color histogram, a shape histogram, and a composition histogram, and calculates a feature amount for each histogram. Note that the feature amount illustrated in FIG. 6 is the third feature amount.

Then, similarity calculator 24 calculates the similarity for each feature amount. Each feature amount is associated in advance with an action of prompting robot 30 to capture a photograph of the external environment.

Next, determiner 25 performs threshold value determination to determine whether each similarity calculated in step S8 is larger than a threshold value (step S9). Then, in a case where any of the similarities is larger than the threshold value, instructor 26 instructs robot 30 to perform a predetermined action corresponding to the feature amount having the highest similarity via network N (step S10).

Action unit 33 of robot 30 that has received the instruction executes an action corresponding to a magnitude of the similarity (step S11). Note that, in a case where the similarity is less than the threshold value in step S10, instructor 26 may instruct robot 30 not to operate, or is not required to send an instruction to robot 30.

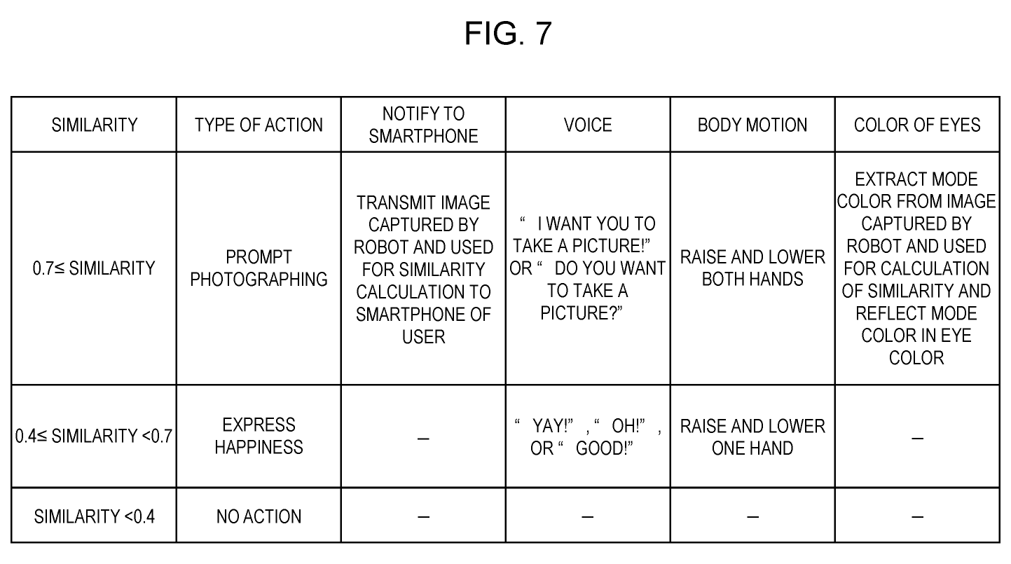

FIG. 7 is a diagram illustrating an example of an action according to the magnitude of the similarity. For example, in a case where the similarity is equal to or greater than 0.7, action unit 33 causes robot 30 to perform an action of prompting user 2 to perform photographing. In a case where the similarity is equal to or greater than 0.4 and less than 0.7, the action unit causes robot 30 to execute an action of expressing happiness. In a case where the similarity is less than 0.4, the action unit does not cause robot 30 to execute the action.

For example, in a case where the similarity is equal to or greater than 0.7, action unit 33 transmits the image captured by robot 30 and used for calculating the similarity to the smartphone of user 2 who owns robot 30, and causes robot 30 to output a voice indicating “I want you to take a picture!” or “Do you want to take a picture?” to prompt user 2 to perform photographing.

Action unit 33 causes robot 30 to execute an action of raising and lowering both hands, extracts a mode color from the image captured by robot 30 and used for calculating the similarity, and changes the color of the eyes of robot 30 to the color.

In a case where the similarity is 0.4 or more and less than 0.7, action unit 33 causes robot 30 to perform an action of expressing happiness. Action unit 33 causes robot 30 to output a voice indicating “Yay!”, “Oh!”, or “Good!” and causes robot 30 to execute an action of raising and lowering one hand.

Note that the action that action unit 33 causes robot 30 to execute is not limited to the action illustrated in FIG. 7, and may be another action. The threshold value is not limited to 0.4 and 0.7, and may be other values, or there may be many threshold values, and action unit 33 may cause robot 30 to execute various actions depending on the magnitude of the similarity.

### Effects and others

In a case where robot 30 acquires a photograph according to the preference of a single user, robot 30 can acquire only a photograph according to the preference of the corresponding user, and in a case where there are two or more users, the robot cannot acquire a photograph according to the preference of the two or more users.

On the other hand, robot system 10 includes server device 20 and robot 30 that acts in response to an instruction from server device 20, the server device including feature amount integrator 23 that generates a third feature amount on the basis of a first feature amount of image data held by a first user and a second feature amount of image data held by a second user, the third feature amount being obtained by integrating the first feature amount and the second feature amount, determiner 25 that determines whether to execute an output to the second user on the basis of similarity between the third feature amount and a fourth feature amount extracted from image data of an external environment, and instructor 26 that performs an instruction of the output in a case where it is determined to execute the output to the second user. As described above, the configuration of robot system 10 is not required to be robot 30, and may be a terminal or the like.

Robot system 10 can prompt photographing on the basis of the feature amount extracted from the photo data of two or more users. As compared with the case of using the feature amount extracted from the photo data of one user, robot system 10 can execute an action of prompting photographing in accordance with the feature amounts extracted from the photo data of two or more users. Therefore, photographing proposal according to the preferences of the two or more users is possible.

For example, feature amount integrator 23 generates the third feature having been weighted on the basis of a weight set for each of the first feature amount and the second feature amount. Robot system 10 can give a photographing proposal strongly reflecting the preference of the first user to the second user who is the owner of the robot or the terminal.

For example, since instructor 26 instructs the second user to execute an action of prompting the second user to photograph the external environment, robot system 10 can prompt the second user to perform photographing.

For example, instructor 26 instructs execution of different actions as the output to the second user in a case where the similarity is larger than the first threshold value and in a case where the similarity is smaller than the first threshold value and larger than the second threshold value. Therefore, robot system 10 can execute different actions in a case where the similarity exceeds the first threshold value and in a case where the similarity exceeds the second threshold value.

For example, the first feature amount and the second feature amount have a plurality of types, each type is associated with a different action of prompting photographing of the external environment, feature amount integrator 23 generates the third feature amount corresponding to each type, and instructor 26 instructs execution of the output to the second user corresponding to the type having the similarity that is highest. Therefore, robot system 10 can store two or more parameters of the feature amount, and can execute the action according to the parameter of the feature amount determined to have a high similarity.

### Other Exemplary Embodiments

Although the exemplary embodiment has been described above, the present invention is not limited to the exemplary embodiment. For example, in the above exemplary embodiment, the order of a plurality of pieces of processing may be changed, or a plurality of pieces of processing may be executed in parallel.

In the above exemplary embodiment, the configuration in which server 20 and robot 30 are connected via network N has been described. However, one or all of the constituent elements of server 20 illustrated in FIG. 2 may be included as the constituent elements of robot 30.

That is, robot 30 may include feature amount integrator 23 that generates a feature amount obtained by integrating feature amounts of image data 3 and 4 held by users 1 and 2 on the basis of the feature amounts of image data 3 and 4, determiner 25 that determines whether to execute the output to the second user on the basis of similarity between the integrated feature amount and the feature amount extracted from the image data of the external environment, instructor 26 that instructs execution of the output to the second user in a case where it is determined to execute the output to the second user, and the like.

In the above exemplary embodiments, each component may be implemented by executing a software program suitable for each component. Each component may be implemented by a program execution unit such as a CPU or a processor reading and executing a software program recorded in a recording medium such as a hard disk or a semiconductor memory.

In addition, general or specific aspects of the present invention may be implemented by a system, an apparatus, a method, an integrated circuit, a computer program, or a computer-readable recording medium such as a CD-ROM. The aspects may be implemented by an arbitrary combination of a system, an apparatus, a method, an integrated circuit, a computer program, and a recording medium.

Besides, the present invention includes forms obtained by making various modifications perceivable for persons skilled in the art to the foregoing exemplary embodiments or forms implemented by combining arbitrarily the constituent elements and functions in the foregoing exemplary embodiments without deviating from the gist of the present invention.

### INDUSTRIAL APPLICABILITY

The present disclosure can be used for an instruction device, a robot system, and a robot capable of making a proposal according to preference of a user.

### REFERENCE MARKS IN THE DRAWINGS

1 user

3 photo data

10 robot system

20 server device

21 storage

22 feature amount extractor

23 feature amount integrator

24 similarity calculator

25 determiner

26 instructor

27 image receiver

30 robot

31 camera

32 instruction receiver

33 action unit

34 image transmitter

41 image

1. An instruction device comprising:
a feature amount integrator that generates a third feature amount on a basis of a first feature amount of image data held by a first user and a second feature amount of image data held by a second user, the third feature amount being obtained by integrating the first feature amount and the second feature amount;
a determiner that determines whether to execute an output to the second user on a basis of similarity between the third feature amount and a fourth feature amount extracted from image data of an external environment; and
an instructor that performs an instruction of the output in a case where it is determined to execute the output to the second user.

2. The instruction device according to claim 1, wherein the feature amount integrator generates the third feature amount having been weighted on a basis of a weight set for each of the first feature amount and the second feature amount.

3. The instruction device according to claim 1, wherein the output to the second user is an action of prompting photographing of the external environment.

4. The instruction device according to claim 1, wherein the instructor instructs a terminal to execute the output to the second user, the first user is not an owner of the terminal, and the second user is an owner of the terminal.

5. The instruction device according to claim 2, wherein the weight of the first feature amount is set to be larger than the weight of the second feature amount.

6. The instruction device according to claim 1, wherein
the instructor
instructs execution of a first action as the output to the second user in a case where the similarity is greater than a first threshold value, and
in a case where the similarity is smaller than the first threshold value and larger than a second threshold value, the instruction device instructs the second user to execute a second action different from the first action as the output to the second user.

7. The instruction device according to claim 1, wherein
the first feature amount and the second feature amount each have a plurality of types,
different outputs to the second user are associated with each of the plurality of types,
the feature amount integrator generates the third feature amount corresponding to each of the plurality of types, and
the instructor instructs execution of the output to the second user corresponding to the type having the similarity that is highest.

8. A robot system comprising:
the instruction device according to claim 1; and
a robot that acts in response to an instruction from the instruction device.

9. A robot comprising the instruction device according to claim 1.
